(19) United States
(12) Patent Application Publication
(10) Pub. No.: US 2012/0328729 A1
(43) Pub. Date: Dec. 27, 2012

(54) FORM MED VIPBARE SIDEKERNER

(75) Inventors: Erik Spangenberg HANSEN, Ostbirk (DK); Kjeid SEJRUP, Karup (DK); Jesper B. Rasmussen, Brabrand (DK)

(73) Assignee: KVM INDUSTRIMASKINER A/S, Kjellerup (DK)

(21) Appl. No.: 13/165,407

(22) Filed: Jun. 21, 2011

(30) Foreign Application Priority Data
Jun. 21, 2011 (DK) PA201000541

(51) Int. Cl. B28B 7/04

(52) U.S. Cl. 425/451.5

(57) ABSTRACT

Pivotable side cores for a lower mold part in a concrete casting machine of the kind typically used for making cast items in the form of concrete blocks for pavements, wall construction or elements, solid blocks and blocks with cavities or recesses.

By the pivotable side cores, recesses can be made at the side of products, where these recesses at the side of the product do not extend through to the top side of the product.

By the invention are indicated pivotable side cores in a lower mold part including means that ensure that the core members forming the cavities retain their position in the lower part during compression, and at the same time are pivoted off the product during the demolding.

### PRIOR ART

U.S. Pat. No. 3,918,877 describes a mold system for making concrete block in which a parallelogram system of rods cause that part of the mold side can be displaced relative to the rest of the mold and the cast element in connection with demolding.

### INTRODUCTION

The present invention concerns a mold system with pivotable side cores for concrete casting machines of the kind typically used for making cast items in the form of concrete blocks for pavements, wall construction and elements with cavities or recesses in the sidewalls.

### DESCRIPTION

The mold system according to the present invention includes a cellular lower part with upwards and downwards open cells that define the desired basic shape of the individual blocks or elements. The cells are divided by cell walls in which pivotable cores protruding inwardly are incorporated for producing recesses at the side of the cast product, the recesses not extending through to the surface of the cast product, and a corresponding upper part, which press plates have pressing pistons projecting downwards from an upper retainer plate, the pressing pistons designed with lower thrust plates which fit into the respective underlying cells in the lower part and thereby are useful for downwards retention in the compression stage, and ejection of the cast items from the cells, and where the lower part includes means ensuring that the pivotable side cores protruding in from the side and forming the cavities in the cast product maintain their position in the lower part during the compression and at the same time are pivoted clear of the product during the demolding.

In connection with casting concrete blocks in which cavities and recesses at the side are wanted which do not extend to the surface of these blocks, it is necessary to have core members that are retracted before or simultaneously with the demolding such that the mold can be lifted without destroying the newly cast product. The cores of this invention pivot upwardly and outwardly during demolding without damaging the product due to the disposition of their point of suspension in relation to the cast product. By certain types of recesses it is required that a steel casting plate belonging to the mold has a construction that keeps the core in position in the mold, and which when the steel casting plate is retracted before demolding allows the core to be pivoted slightly downwards before the mold starts its upward movement in the demolding movement. This construction on the steel casting plate protects the production plate at the same time when the mold is lowered again before the next cycle. During the lowering of the mold, the core is pivoted back to its original position in the mold. A steel casting plate is often used for protecting the production plate during the production. A steel casting plate is always used if profilings are desired at the underside of the cast products. The steel casting plate functions in the way that it is disposed between the production plate and the lower mold part. The steel casting plate is placed here during filling and during compression of the concrete which occurs by strong shock vibration of production plate and mold from below by a vibration table. After ending compression, the steel casting plate is drawn out, allowing products to be disposed on the production plate during demolding before they are moved out of the machine, and a new production plate is moved in together with the steel casting plate.

The system is used in the way that the lower part of the mold is placed on a production plate, typically with a steel casting plate between the lower part and the production plate. All the parts are placed on a vibration table and with the upper part of the mold disposed at an elevated position above the lower part.

A concrete filling vehicle is moved along the top side of the lower part in the space below the upper part for filling concrete into the casting cells. After filling, the filling vehicle is drawn out, and the upper part is lowered until the said thrust plates abut on the concrete surfaces in respective casting cells. Then the upper part is used as a multi-pressure piston for compressing the concrete mass in the individual casting cells, which is effected under strong vibration of the mold system for separating air from the concrete mass. Hereby, the cast items are compressed for the desired compact block shape and uniform thickness.

The steel casting plate is drawn out from its position between production plate and lower part, after which the mold system is lowered for contact with the production plate. Subsequently, the upper part is retained at its level relative to the lower part, and the lower part is acted on by force to be elevated from the production plate whereby the cast items, which by the retained position of the upper part do not participate in this elevation, will remain standing on the casting board during the demolding.

When the demolding has ended by elevation of the bottom part to a position at which its underside is elevated to at least the level of the pressing plates of the upper part, the semi-solid cast items can be removed from the vibration table by pushing out therefrom after lifting the upper part, after which a new casting cycle can be initiated after lowering the lower part to the next inserted production plate with steel casting plate and elevating the upper part to its starting position.

Previously, recesses at the side of the concrete blocks which did not extend through to the surface have only been possible to be made either by complicated steel casting plates which frequently are very difficult to clean, or by means of cores mounted in the lower part of the mold and which could be retracted by means of hydraulic or pneumatic cylinders.

Steel casting plates with large and/or complicated constructions require that the mold is to be guided accurately down over the steel casting plate, most often by guide pins mounted on the steel casting plate which then fits into guide holes in the mold when the mold is lowered in the concrete filling. Besides, it can be very difficult to make the products remain in the mold during the special demolding sequence required by such steel casting plates. By demolding, the lower and upper mold parts are first to be lifted off the construction on the steel molding plate before the steel casting plate can be retracted. Then the lower and upper mold parts are to be lowered for contact with the production plate before the lower mold part can be lifted off the newly cast products. During the first lifting of the lower and upper parts of the mold, it is very critical that the product is compressed sufficiently in order to participate in the lifting; in addition, it is critical that the product is released from the construction on the steel casting plate. This demolding can only take place by products in cases where the amount of concrete in relation to the design allows it, that is if the weight of the concrete does not exceed the friction at the outer walls and the cohesive capacity of the concrete. The cross-sectional height is not to exceed the cross-sectional width in order to function properly, but at the same time the weight of the concrete must not be too great, i.e. no massive concrete lumps. This elevating and lowering of the lower and upper parts is preferably also to occur with the lower and upper parts of the mold interlocked. Such a facility is typical auxiliary equipment for machines of this type.

Cores which are pulled off the product by means of hydraulics or pneumatics have the disadvantage that they are more space consuming than cores which only pivot out due to their position and self-weight. These solutions demand extra space, greater complexity and also require auxiliary equipment on the machine, changes in the control of the machine and thereby increased equipment costs as well as increased casting cycle times, entailing substantial disadvantages.

It is thus the object of the present invention to indicate a solution to these problems in the form of an improved lower part of the mold.

The invention contributes to this object by a simple system which due to its point of suspension provides a mechanism which during a pivoting movement retracts the side cores before or simultaneously with the demolding. The invention thus provides a lower mold part for use in a mold system comprising a frame delimiting a casting compartment and at least one pivotable core member arranged pivotably around an axle, where the axle is arranged outside the casting compartment such that a part of the core member forms cavity/recess in the produced item, and where the lower mold part further comprises means for securing said core member forming the cavity in a fixed position in the mold part during filling of the mold system as well as during compaction of the product such that the core member due to its position and pivotable arrangement around the shaft will pivot off the product during the demolding when the lower part is vertically displaced relative to the rest of the mold system.

Additional advantageous embodiments are indicated in the dependent claims.

The invention is described briefly with reference to the drawing, on which:

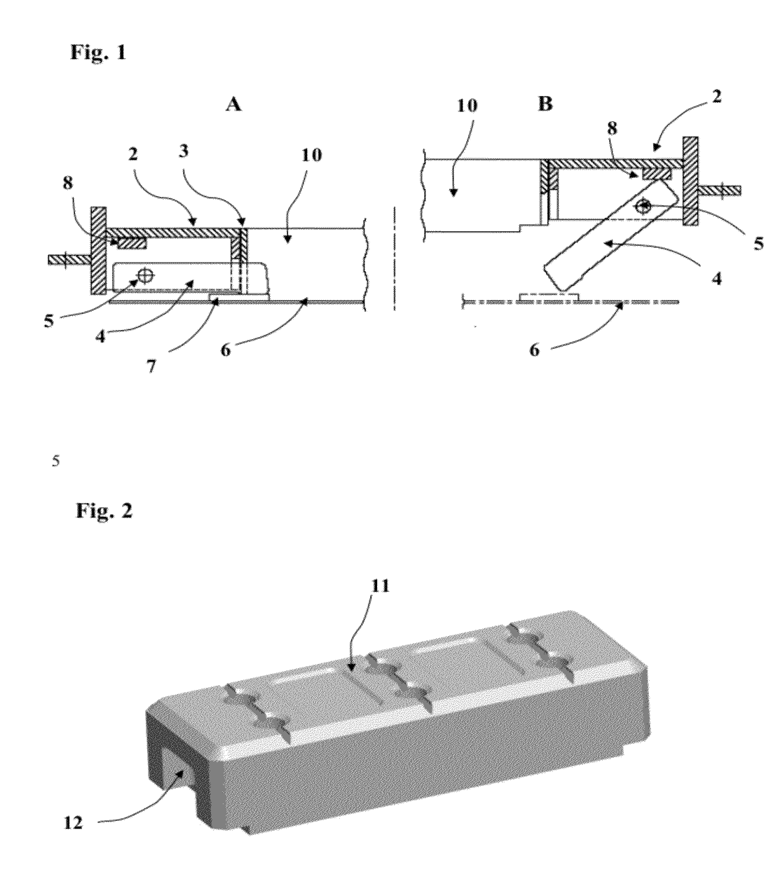

FIG. 1 shows a sectional view of closed and demolded function, respectively, of the pivotable side core.

FIG. 2 shows a view of the product coming out of the mold shown in FIG. 1 where the invention may find application during production.

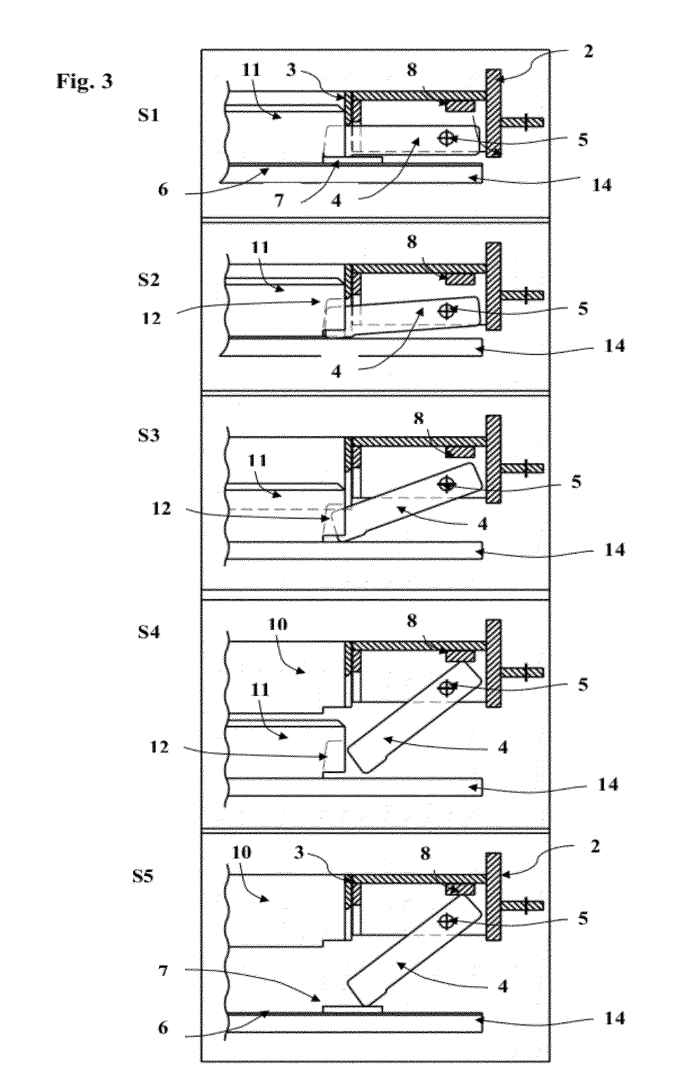

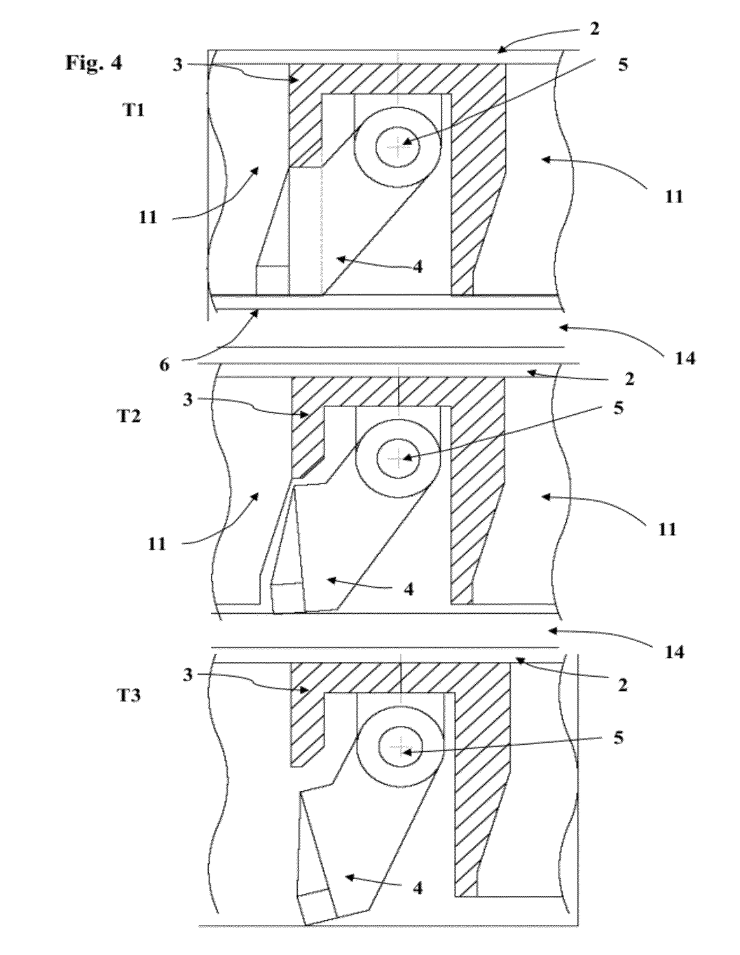

FIG. 3 shows a series of images of the function of the pivotable core.

FIG. 4 shows a series of images of a second embodiment of the invention.

FIG. 1 shows a lower mold part 2 in a lowered and closed position A and an elevated and open position B, respectively. The lower mold part 2 shows an embodiment of a pivotable side core 4 which is hinged by an axle 5, allowing the side core to be retained between the construction 7 on the steel casting plate 6 and the insert 3 in the lower mold part when the lower part 2 is lowered down upon the steel casting plate 6 which lies on a not shown production plate. The insert 3 contains the cell openings 10 that indicate the outer contours of the product to be cast 11.

FIG. 2 shows a product 11 with a recess 12 at the side of the product which is produced in a lower mold part 2 shown in FIG. 1.

FIG. 3 shows the side core 4 at the various positions during demolding of a product 11.

S1 shows the position of the side core 4 after ending compression of the product 11 in the lower part 2 where the steel casting plate 6 with construction 7 rest on the production plate 14. Here it appears that the side core 4 is retained between the insert part 3 in the lower part 2 and the construction 7 on the steel casting plate 6, which in turn is disposed upon the production plate 14.

S2 shows the situation where the steel casting plate 6 presently is pulled away, and the side core has now released the product 11 and rests on the production plate 14. The lower part 2 with the product 11 is lowered down to the production plate 14 after the steel casting plate 6 has been pulled away.

S3 shows a situation during lifting of the lower part 2 during demolding; the situation is right where the side core 4 is closest to the edge of the recess 12. As it appears, the disposition of the shaft 5 provides the movement of the side core providing that the side core 4 does not touch the product 11 at the edge of the recess 12.

S4 shows the situation where the lower part 2 has been lifted off the product 11. The side core is now suspended on a spacer block 8, the thickness of the spacer block 8 being adapted such that the side core 4 pivots sufficiently around its axle 5 until it just goes clear of the product 11 after finishing demolding. At this position, the production plate 14 with the newly cast product 11 can be pushed out.

S5 shows the situation where the recently produced product has been pushed out, and a new production plate 14 is pushed in under the elevated lower part 2. The production plate 14 simultaneously also brings the steel casting plate 6 with construction 7 in under the lower part 2 which is then lowered, thereby bringing the side core 4 into its position in the lower part 2 between construction 7 and the inserts 3, ready for a new cycle.

FIG. 4 shows a second embodiment of the invention, where the side core 4 is shown with a suspension point for the shaft 5 within the insert 3. This embodiment is shown in three situations, T1 to T3.

T1 shows the situation in which the lower part 2, here shown as the insert 3, stands on the casting plate 6, resting on the production plate 14 after finishing filling and compression of the product 11. The side core 4 suspended by the axle 5 has made the recess in the product 11.

T2 shows the situation where the steel casting plate 6, not shown, is retracted and the product 11 is still located in the cellular insert 3, and due to its suspending by the axle 5, the side core 4 is pivoted clear of the product 11. By relatively small products 11, the product 11 remains in the insert 3 after withdrawal of the steel casting plate 6. By the product 11 shown here it is not required with a construction on the steel casting plate 6.

T3 shows the situation where the lower part 3 is lifted off the product and the demolding is finished, and the side core 4 is suspended by its axle 5 before the lower part 3 is lowered again into contact with the not shown steel casting plate 6 on the not shown production plate 14.

### LIST OF REFERENCE NUMBERS

2. lower mold part
3. inserts in lower part
4. pivotable core
5. axle around which core pivots around
6. steel casting plate with profile
7. construction on steel casting plate
8. spacer block for stopping pivoting of the core
10. cell opening in lower part
11. product with recess at the side
12. recess at the side of the product
14. production plate

1. A mold part for use in a mold system for casting products, wherein said system has a production plate, said mold part comprising: a frame together with said production plate limits a casting compartment; at least one swingable core member arranged in said mold part, said core member pivotably arranged around an axle, arranged outside the casting compartment; means for securing said core member in a fixed position in the mold part, during filling of the mold system with castable material as well as during compaction of said castable material, such that said core member due to its position and pivotable mounting swings free of a product, when said production plate is vertically displaced relative to said mold part.

2. A mold part according to claim 1, wherein a steel casting plate is placed between a lower mold part and an underlying production plate.

3. A mold part according to claim 2, in wherein the steel casting plate has a profile ensuring that the core member is in a position for making a deeper recess but at the same time, before demolding, said core member commences its pivoting such that said core member is kept clear of the product.

3. A mold part according to claim 3, wherein the core member and profile on the steel casting plate are made of hardened steel.

4. A mold part according to claim 1, wherein a cutout is made in a frame of a lower mold part, the cutout being closed upwardly such that the cutout forms an upper limitation for movement of the core member.

5. A mold part according to claim 1, wherein the axle is mounted in the swingable core member such that the core member extends at both sides of the axle, and a frame having a stop mounted therein such that a part of the core member facing away from the casting compartment limits pivoting of the core member by abutting on the stop.
